(19) United States
(12) Patent Application Publication
(10) Pub. No.: US 2005/0061947 A1
(43) Pub. Date: Mar. 24, 2005

(54) General-purpose multicavity cassette mould for producing building keyblocks

(76) Inventors: Vladimir Vyacheslavovich Smirnov, Ryazan (RU); Alexei Viktorovich Abramychev, Moscow (RU); Vladimir Konstantinovich Sergeev, Saratov (RU); Konstantin Borisovich Sergeev, Saratov (RU); Sergey Vasilievich Bondarevskiy, Moscovskaya obl (RU)

Correspondence Address: WILLIAM COLLARD;COLLARD & ROE, P.C., 1077 NORTHERN BOULEVARD, ROSLYN, NY, 11576, US

(21) Appl. No.: 10/494,179

(22) PCT Filed: Oct. 30, 2002
(86) PCT No.: PCT/RU02/00472

(30) Foreign Application Priority Data
Nov. 2, 2001 (RU) 2001129529

(51) Int. Cl. B28B 7/24

(52) U.S. Cl. 249/140; 249/120

(57) ABSTRACT

The invention relates to building construction and to the production of building products and can be used for constructing low rise residential, industrial and administrative buildings for different climatic zones. The invention increases the quality of products having a complicated configuration, extends the range thereof and makes it possible to obtain a precise geometrical shape of the products. The inventive general-purpose multicavity cassette mould for producing grouted building keyblocks comprises a frame provided with a tray (1) on which lodgements (2) are arranged, the number of the lodgements corresponds to the number of formed sections. A crossbeam (3) being the lower in the operative position thereof is provided with fixing elements. Rotatable coupled pull rods (4) are provided with clamping elements (5). A demountable crossbeam (6) being the upper in the operative position thereof is also provided with the fixing elements. Moulding divisions are formed by side T-shaped elements, an end upper element, cavity-forming elements and by metallic bottoms.

### FIELD OF THE INVENTION

The invention relates to the civil engineering and production of structural elements and can be used in construction of few-storey apartment houses and industrial-and-office buildings under various environmental conditions.

### PRIOR ART

A casing form is known in prior art to consist of a tray, L-shaped movable flexible separating walls with partitions, the walls defining the forming compartments, and a bracing device comprising a rod with means for moving it, wherein an opening is provided at the top of each separating wall for passing the rod of the bracing device therethrough—see in the specification: USSR Inventor's Certificate No. 1576338, Int. Cl. B28B 7/24, publ. 1988.

The known casing form allows to manufacture only a rather narrow range of structural elements of inadequate quality.

The closest prior art technical solution is represented by a multiple casing form for the manufacture of structural elements from structural mixes, said casing form containing a tray having a stop and a clamping device, with a stack of vertically mounted flexible walls with sides arranged to be disposed between them, the walls defining the forming compartments—see in the specification: Russian Inventor's Certificate No. 2021111, Int. Cl. B28B 7/24, publ. 1994.

The known casing form allows to manufacture only a rather narrow range of structural elements of inadequate quality.

### DISCLOSURE OF THE INVENTION

The engineering effect of the invention consists in improving quality and widening the range of structural elements made of structural mixes and having various configurations with a complicated profile of the surfaces to be interconnected with each other as well as in obtaining a high-precision geometrical shape.

The engineering effect is accomplished owing to that, in the general-purpose casing form for the manufacture of structural key blocks from structural mixes, comprising a frame having a tray and a clamping device, with a stack of vertically mounted separating walls with sides and metal bottoms arranged to be disposed between them, the walls defining the forming compartments, cradles are fixed rigidly to the frame having the tray, a lower, when in its working position, supporting cross-piece is provided with fixing means, to which cross-piece are attached dual swivel drawbars provided with clamping devices for clamping them in fixing means of a removable upper cross-piece, and the forming compartments are defined by the side members of tee section, an upper end-face member, void-forming cores and metal bottoms; besides, the form is further provided with metal diaphragms for producing supplemental structural half-elements, and the side member, the upper end-face member and the void-forming cores are made of an elastic material, for instance, a plastic; in addition, the side member consists of the separating wall, two sides, stiffening ribs with projections, grooves for fixing the projections, five inner and outer chamfer-forming members, and on the inner side thereof, in order to form keyed joints, there are provided horizontal and vertical trapezoidal projections, the void-forming cores are made as truncated prisms or cones and are provided with fixing shanks, the separating walls have projecting shelves with fixing bosses, and the upper end-face member is provided with the sides and the stiffening ribs that are cut off at the level of the chamfer-forming members, while the number of cradles corresponds to the number of the forming compartments, and the bottoms are further provided with elements for producing three-dimensional decorative patterns on the front faces of the structural elements.

### BRIEF DESCRIPTION OF THE DRAWINGS

The invention is now described in detail with reference to the accompanying drawings, where:

FIG. 1 illustrates the general-purpose multiple casing form for the manufacture of structural key blocks from structural mixes, shown when it is assembled;

FIG. 2 illustrates the general-purpose multiple casing form for the manufacture of structural key blocks, shown when it is in its operating position on the tray of the frame;

FIG. 3 is a view of the casing form along arrow A in FIG. 2;

FIG. 4 is a sectional view of one section of the casing form shown in FIG. 1;

FIG. 5 is sectional view B-B of FIG. 4;

FIG. 6 is sectional view D-D of FIG. 5;

FIG. 7 illustrates an interconnecting unit of the forming compartments;

FIG. 8 illustrates how the steel bottoms are fastened and the groove-forming members of the keyed joints are arranged; and

FIG. 9 illustrates the structural element—i.e., a structural key block—produced in the general-purpose multiple casing form.

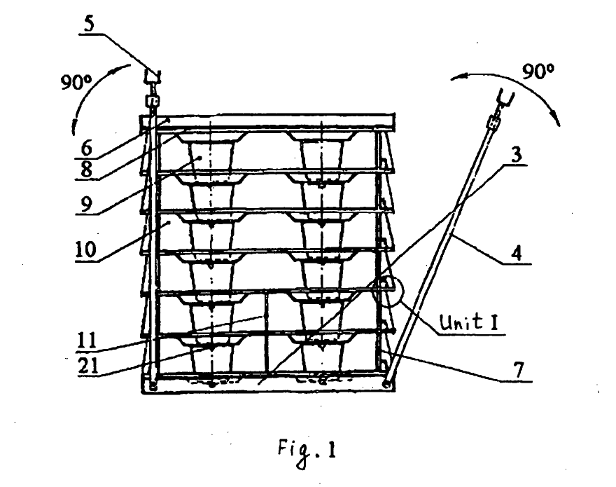

The general-purpose multiple casing form for the manufacture of structural key blocks from structural mixes comprises a frame having a tray 1, whereto cradles 2 are rigidly fixed, the number of cradles corresponding to the number of the forming compartment. A lower, when in its working position, supporting cross-piece 3 is provided with fixing means. Dual swivel drawbars 4 are provided with clamping devices 5. An upper, when in its working position, removable cross-piece 6 is also provided with fixing means. The forming elements are made as side members 7 of tee section and an upper end-face member 8, whereas void-forming cores 9 are made as truncated plastic prisms or cones, metal, for instance, steel bottoms 10 and metal, for instance, steel diaphragms 11 for producing supplemental structural half-elements. The side member 7, the upper end-face member 8 and the void-forming cores 9 are made of an elastic material, for instance, plastic, rubber, etc. The side member 7 consists of a separating wall 12, two sides 13, stiffening ribs 14 with projections 15, grooves 16 for fixing the projections, inner and outer chamfer-forming members 17, an inner and outer two-way groove 18 for fixing the diaphragms 11, and on the inner side of groove-forming members, in order to form keyed joints, there are provided horizontal and vertical trapezoidal projections 19, and on the outer side thereof, projecting restrictors 20. The void-forming cores 9 are provided with fixing shanks 21. The separating walls 12 have projecting shelves 22 with fixing bosses 23. The upper end-face member 8 is similar to the side member 7, with the difference that the sides 13 and the stiffening ribs 14 thereof are cut off at the level of the chamfer-forming members 17. The bottoms 10 are further provided with elements for producing three-dimensional decorative patterns on the front faces of the structural elements.

### THE BEST EMBODIMENT OF THE INVENTION

The general-purpose multiple casing form for the manufacture of structural key blocks from structural mixes operates as follows.

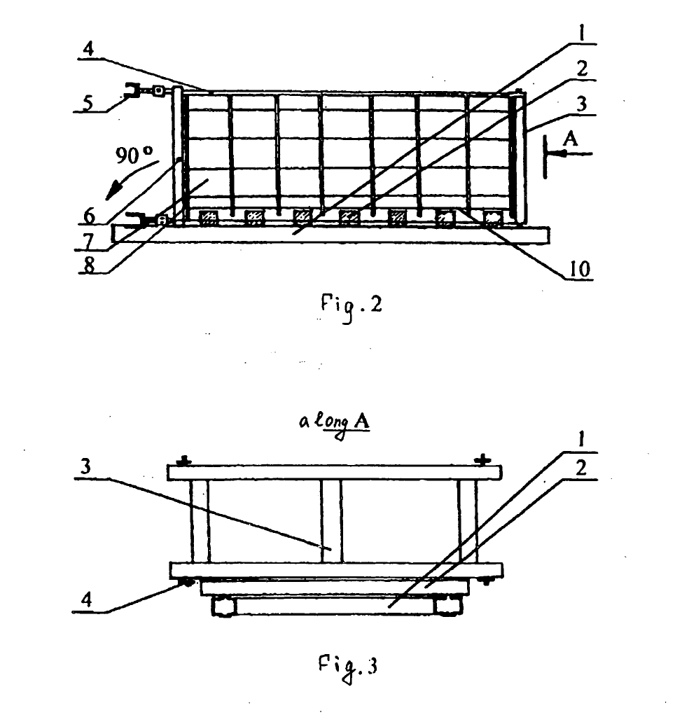

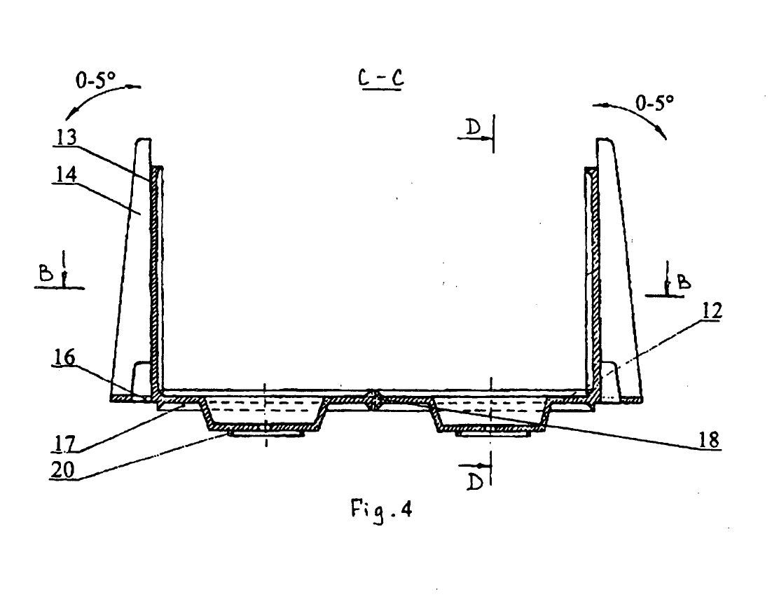

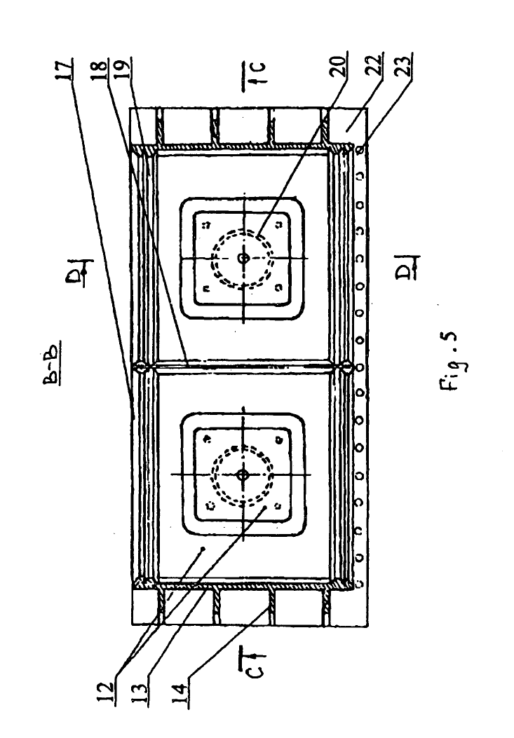

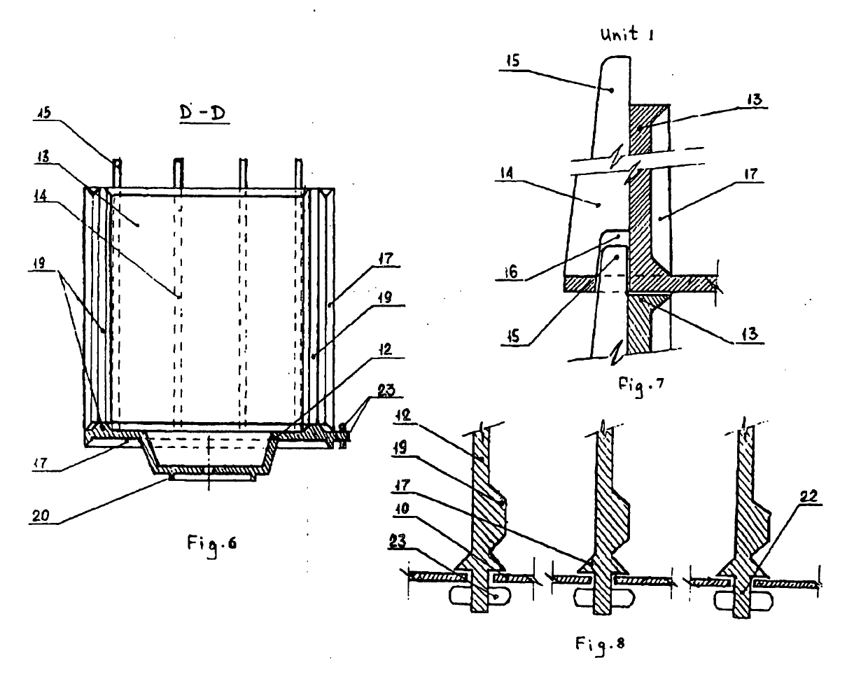

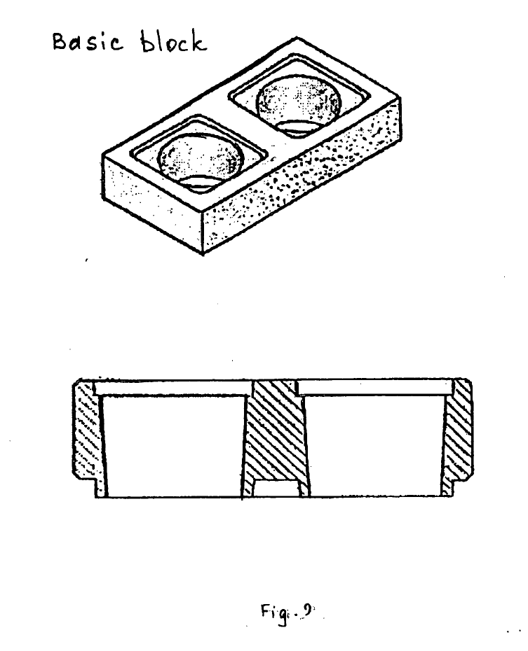

The general-purpose multiple casing form for the manufacture of structural key blocks from structural mixes is installed flatways in a horizontal position. In the lower supporting cross-piece 3 having swivel drawbars 4 is to be mounted, using the fixing means of the lower cross-piece, the side member 7 so that the sides 13 and the stiffening ribs 14 thereof would face upwards. Then, if it is necessary to produce hollow structural elements, the elastic void-forming cores 9 made, for instance, of plastic or rubber are installed in the openings provided for this purpose in the separating wall 12 where they are fixed by means of shanks 21. Further on, the subsequent side members 7 are installed therein so that the upper edges of the void-forming cores 9 get fixed in the projecting restrictors 20, the stiffening ribs 14 getting simultaneously fixed by means of the projections 15 in the grooves 16. Next, the upper end-face member 8 is installed onto which the upper removable cross-piece 6 is then mounted where it is locked by the fixing means. The dual swivel drawbars 4 are brought to their vertical position and, by rotating the coupling bolts of the clamping device 5, the compartments of the casing form are preliminarily braced. Thereupon, the steel bottoms 10 are installed into all the forming compartments (FIG. 8), using the fixing bosses 23, and the members of the casing form are then braced finally until the separating walls 12 fit on the ribs of the separating sides 13 (FIG. 7). If necessary, the bottoms are further provided with elements for producing three-dimensional decorative patterns. The casing form is then brought to its operating position by turning it through 90° and placed with its bottoms 10 down onto the cradles 2 of the frame of the tray 1 as shown in FIGS. 2 and 3.

After the casing form is filled up with the structural mix poured therein and the mix gets set, dismantling of the casing form is carried out and the finished structural elements are then removed therefrom, for which purpose the coupling bolts are to be unscrewed, followed by swinging away the swivel drawbars 4 and taking the upper removable cross-piece 3 off, whereupon the end-face member 8 is to be remove so that the finished structural key blocks can be taken out. The dismantling of the casing form is to be carried out successively, starting from the compartment which is located immediately beneath the upper removable cross-piece, for which purpose the first compartment is displaced by means of flat mounting tools, while using the cradle 2 as a guide, so that the projections 15 of the tee-section member 7 would leave the grooves 16, with the shanks 21 getting simultaneously released from the respective openings. Next, by tipping the casing form through 90° as shown in FIG. 2, the tee-section member 7 is shifted to its horizontal position, with the separating wall 12 thereof facing upwards. Then, the separating sides 13 are to be bent slightly outwards, so that the side member 7 can be easily removed from the finished structural element. Along with this, the bottoms 10 and the void-forming cores 9 are also to be separated from the finished structural element.

The key blocks are made, for instance, from a gypsum expanded-clay lightweight concrete mix, with the content of expanded clay aggregate in the mix being as high as up to 40% by volume. It is possible to make use of the key blocks as fencing structures for walls of buildings, based on a composition of gypsum binders.

### Industrial Applicability

The invention allows improving quality and widening the range of structural elements having various shapes with a complicated configuration of the surfaces to be interconnected with each other as well as obtaining a high-precision geometrical shape. The design of the general-purpose multiple casing form for the manufacture of key blocks has been developed so as to enable installing such casing forms both at stationary and speedily deployed miniplants, thus allowing both to cut down the period of construction and reduce the cost of buildings a few times. The key blocks are produced from various structural mixes, but preferably from fast-hardening mixes.

The general-purpose multiple casing form for the manufacture of key blocks from fast-hardening structural mixes based on a composition of gypsum binders allows to improve quality of the structural elements owing to possible variations in their constructional and thermal-physical parameters and, besides, it allows widening the range of structural elements having a complicated configuration and obtaining a high-precision geometrical shape of the structural elements thus produced, i.e., it provides accuracy within ±0.5 mm when fitting the structural elements, thus ensuring that the wall has an ideally smooth surface without any projections at the joints.

1. A general-purpose multiple casing form for the manufacture of structural key blocks from structural mixes, comprising a frame having a tray and a clamping device, with a stack of vertically mounted separating walls with sides arranged to be disposed between them, the walls defining the forming compartments, characterized in that cradles are fixed rigidly to the frame having the tray, a lower, when in its working position, supporting cross-piece is provided with fixing means, to which cross-piece are attached dual swivel drawbars provided with clamping devices for clamping them in fixing means of a removable upper cross-piece, and the forming compartments are defined by the side members of tee section, an upper end-face member, void-forming cores and metal bottoms.

2. The general-purpose multiple casing form for the manufacture of structural key blocks from structural mixes according to claim 1, characterized in that the form is further provided with metal diaphragms for producing supplemental structural half-elements.

3. The general-purpose multiple casing form for the manufacture of structural key blocks from structural mixes according to claim 1, characterized in that the side member, the upper end-face member and the void-forming cores are made of an elastic material, for instance, a plastic.

4. The general-purpose multiple casing form for the manufacture of structural key blocks from structural mixes according to claim 1, characterized in that the side member consists of the separating wall, two sides, stiffening ribs with projections, grooves for fixing the projections, inner and outer chamfer-forming members, and an inner and outer two-way groove for fixing the diaphragms.

5. The general-purpose multiple casing form for the manufacture of structural key blocks from structural mixes according to claim 1, characterized in that, on the inner side of groove-forming members, in order to form keyed joints, there are provided horizontal and vertical trapezoidal projections, and on the outer side thereof, projecting restrictors.

6. The general-purpose multiple casing form for the manufacture of structural key blocks from structural mixes according to claim 1, characterized in that the void-forming cores are made as truncated prisms or cones and are provided with fixing shanks.

7. The general-purpose multiple casing form for the manufacture of structural key blocks from structural mixes according to claim 1, characterized in that the separating walls have projecting shelves with fixing bosses.

8. The general-purpose multiple casing form for the manufacture of structural key blocks from structural mixes according to claim 1, characterized in that the upper end-face member is provided with the sides and the stiffening ribs that are cut off at the level of the chamfer-forming members.

9. The general-purpose multiple casing form for the manufacture of structural key blocks from structural mixes according to claim 1, characterized in that the number of cradles corresponds to the number of the forming compartments.

10. The general-purpose multiple casing form for the manufacture of structural key blocks from structural mixes according to claim 1, characterized in that the bottoms are further provided with elements for producing three-dimensional decorative patterns on the front faces of the structural elements.
